(19) United States
(12) Patent Application Publication
(10) Pub. No.: US 2016/0171564 A1
(43) Pub. Date: Jun. 16, 2016

(54) SUBJECT APPRAISAL DISCREPANCY ANALYSIS

(71) Applicant: Fannie Mae, Washington, DC (US)

(72) Inventors: Franklin Carroll, Silver Spring, MD (US); Eric Rosenblatt, Derwood, MD (US); Felix G. Meale, North Bethesda, MD (US); Sampat Saraf, Great Falls, VA (US); Adam Davis, Alexandria, VA (US)

(21) Appl. No.: 14/567,533

(22) Filed: Dec. 11, 2014

(51) Int. Cl. G06Q 30/02; G06F 17/30

(52) U.S. Cl. CPC G06Q 30/0278; G06F 17/30371

(57) ABSTRACT

A system and method for analyzing a subject appraisal detects discrepancies and determines likely causes. This is done by accessing several data structures which correspond to appraisals that each contain data regarding property characteristics of a particular property. Data for different appraisals is then compared according to one or more rules. Depending on the result of the comparison and in light of the rules, a message, flag, or warning may be generated. In this manner, possible instances of fraud or misrepresentation may be detected.

### BACKGROUND

1. Field of the Invention

This application relates generally to automated analysis of price appraisal data. More specifically, the application relates to a system and method for performing automated analysis and comparison between different appraisals of the same real property.

2. Description of the Related Art

A property appraisal is an opinion of the value of a particular property based on certain facts. For residential properties, property appraisals are made by a residential appraiser based on facts ascertained by the appraiser. Generally, the appraiser estimates the value of the property that is the subject of appraisal (the “subject property”) by one or more of several valuation methods.

The sales comparison approach is the primary valuation method used for most residential appraisals in the United States. This approach is based on the assumption that home purchasers will pay no more for a property than it would cost to purchase a comparable substitute property. Because it is rare to find two identical houses for sale at the same time in the same neighborhood, appraisers typically select comparable sales (“comps”) that vary from the subject property on a variety of factors, and then account for the differences using a formal adjustment process. The resulting opinion of subject property market value should represent the appraiser's professional conclusion, based on market data, logical analysis, and judgment.

In this method, the appraiser first documents facts about the subject property and obtains facts about the recent sales of other properties in the local market. From these facts, the appraiser identifies the comps by determining which property characteristics drive value in the subject property's market and selecting the properties that are most similar to the subject property in these respects. In addition to physical property characteristics, recency of sale and geographical proximity are key factors in determining similarity.

Next, the appraiser calculates dollar-value adjustments for differences in property characteristics between each comp and the subject. For each feature where the comp is inferior to the subject property, the appraiser adds value to the sale price of the comp. For each feature where the comp is superior, the appraiser subtracts value. The end result of all adjustments should equal the market value of the subject property. The appraiser then reconciles the adjusted value of the various comps and calculates the appraisal value of the subject property by determining an appropriate weighted average for the values of the adjusted comps.

Other valuation methods may be used as an alternative to the sales comparison approach. For example, the appraiser may use a cost approach, by which the appraiser documents facts about the subject property and therefrom calculates an estimated cost to build an equivalent property. Furthermore, the appraiser may use an income approach, by which the appraiser estimates a rental income potential of the subject property (for example, an estimated monthly market rent) and therefrom derives the estimated value of the subject property. In each of these valuation methods, the final appraisal depends on property characteristics determined by the appraiser.

Accordingly, in each of these valuation methods, errors or fraud by the appraiser will affect the result of the appraisal. For example, an appraiser looking to inflate the value of an appraised property may do so by providing false information regarding the property characteristics of the subject property, which is less likely to be noticed by reviewers than characteristics of the comps. This is especially true in the case of a refinance transaction where there is little to no chance of another appraiser using the subject property as a comp.

However, a manual analysis of the voluminous data is typically impossible or impractical. As such, there exists a need for a system and method for conducting automated analysis of appraisals of a subject property (“subject appraisals”) as a tool in the discovery of fraud.

### SUMMARY

Various aspects of the present disclosure relate to a system and method for comparing different subject appraisals on the same property, analyzing the appraisals using various algorithms and alternative data sources to eliminate likely cases of legitimate differences between appraisals, and thereby determining likely cases of appraisal fraud or error.

Specifically, various aspects of the present disclosure analyze a particular subject appraisal (the “target appraisal”) to determine whether the target appraisal contains indicators of error or fraud on one or more property characteristics.

In this manner, the present disclosure provides for an automated analysis of data structures corresponding to two or more appraisals of the same property, with various logic rules to determine likely appraiser intent and possible justification for disagreement, and may be used to ensure the accuracy of appraisal data and detect fraud. According to various aspects of the present disclosure, both the underlying technological process of automated appraisal data analysis and the operation of a computer performing said automated appraisal data analysis may be improved.

The present disclosure can be embodied in various forms, including business processes, application-specific computer implemented methods, computer program products, computer systems and networks, user interfaces, application programming interfaces, and the like. The foregoing summary is intended merely to provide a general overview of various aspects of the present disclosure, and is not intended to limit the scope of this application in any way.

### BRIEF DESCRIPTION OF THE DRAWINGS

These and other more detailed and specific features of various embodiments are more fully disclosed in the following description, reference being had to the accompanying drawings, in which:

FIG. 1 illustrates an example of a property appraisal form for use with various embodiments of the present disclosure.

FIG. 2 illustrates an example of a cost form for use with various embodiments of the present disclosure.

FIG. 3 illustrates an example of an income form for use with various embodiments of the present disclosure.

FIGS. 4A and 4B are exemplary process flows of an operation of an appraisal discrepancy analysis application.

FIGS. 5A and 5B are exemplary devices for executing an appraisal discrepancy analysis application.

FIG. 6 is a block diagram according to a first example of a system in which an appraisal discrepancy analysis application operates.

FIG. 7 is a block diagram according to a second example of a system in which an appraisal discrepancy analysis application operates.

### DETAILED DESCRIPTION OF THE INVENTION

In the following description, numerous details are set forth, such as flowcharts, data tables, and system configurations. It will be apparent to one skilled in the art that these specific details are merely exemplary and explanatory, and are not intended to limit the scope of this application.

Systems and methods are disclosed that provide a party to a real estate transaction, such as a mortgage guarantor, with the means to evaluate the legitimacy of a real estate appraisal. Although discussed herein in the context of real estate appraisals, it should be understood that the systems and methods herein disclosed are not limited to real estate appraisals, but have application with respect to other types of appraisals and valuation judgments.

[Appraisal]

An appraisal (for example, a real estate appraisal, property valuation, or land valuation) in general may be a process of valuating real property, where the value sought is a market value. The appraisal may be recorded on a form (for example, an appraisal form), an example of which may be a uniform residential appraisal report form in conformance with a particular standard, such as a Uniform Appraisal Dataset (UAD) standard.

Data recorded on the appraisal form may be uploaded to a database, an example of which may be a Uniform Collateral Data Portal® (UCDP®). Where the appraisal form is an electronic form, such as an Extensible Markup Language (XML) form or a fillable Portable Document Format (PDF) form, the data may be automatically uploaded to the database. Where, on the other hand, the appraisal form is a paper form, the data may be uploaded to the database by hand or by an electronic data reading technique, such as Optical Character Recognition (OCR).

In general, the appraisal data comprises various property characteristics related to the subject property. In this sense, a property characteristic is an item of data relating to a physical characteristic or other attribute of the subject property or to a sale of the subject property. For example, a property characteristic may represent one of a sale date, a gross living area (GLA), a lot size, an exterior type, a quality of construction, an age, a condition, a number of bedrooms, a number of bathrooms, the presence or absence of a basement, and the presence or absence of a garage, or the like. Respective data fields of the above-described databases may store values corresponding to the property characteristics.

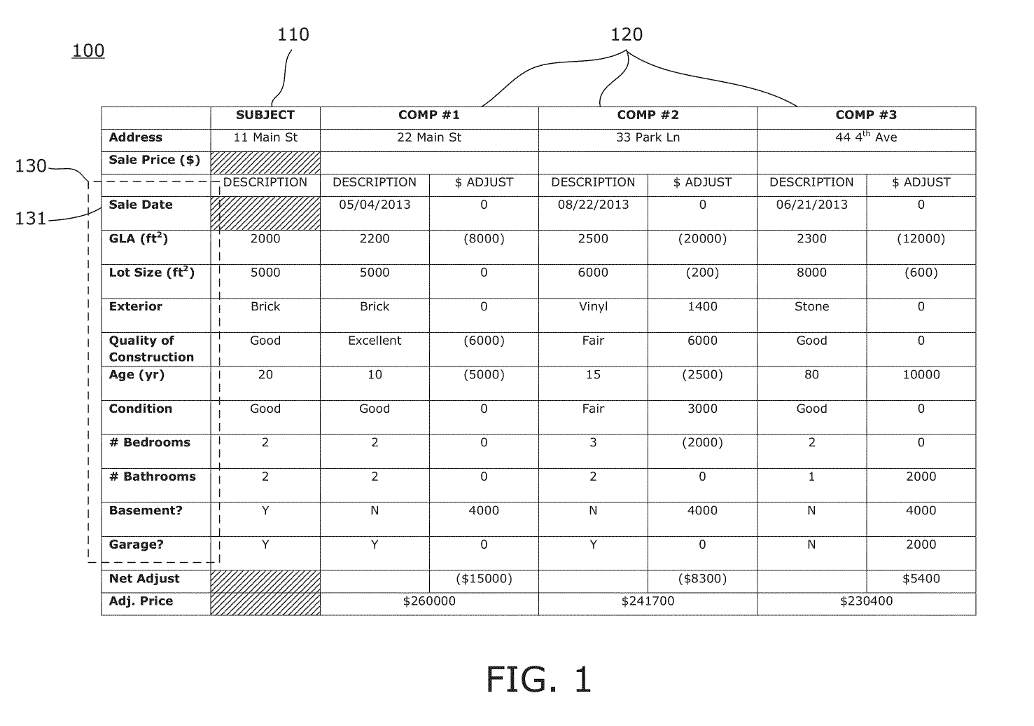

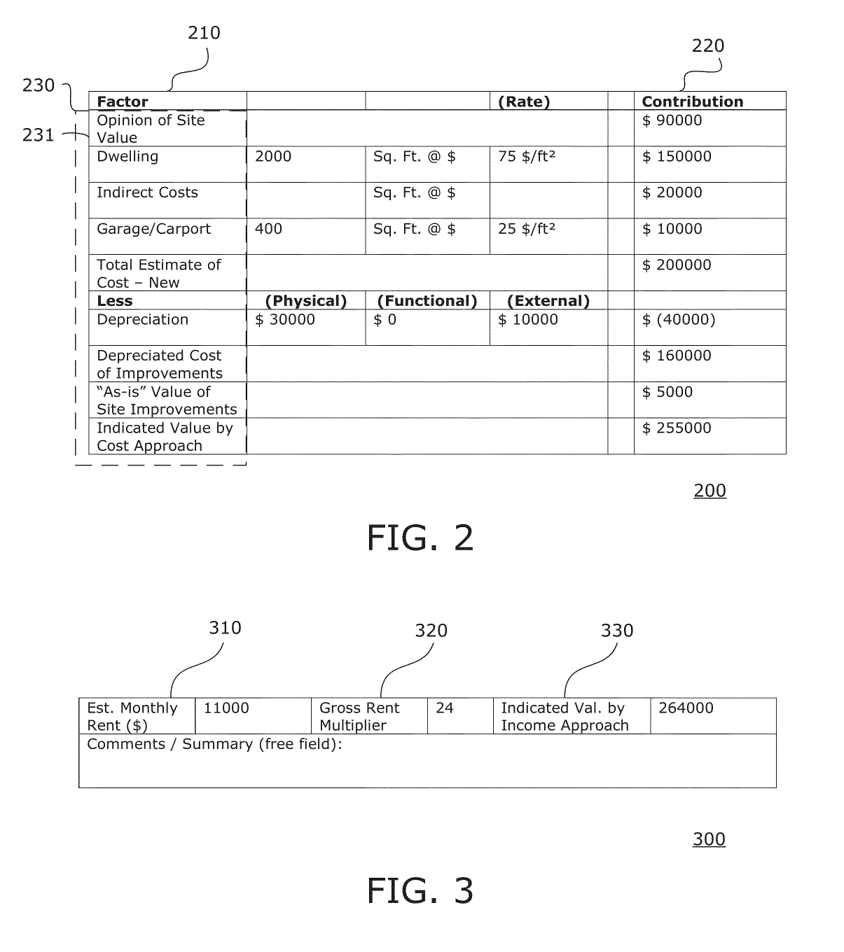

FIGS. 1-3 illustrate examples of various forms 100-300 which may be used to collect appraisal data. FIG. 1 illustrates a form 100 for use in a sales comparison approach. FIG. 2 illustrates a form 200 for use in a cost approach. FIG. 3 illustrates a form 300 for use in an income approach. Although illustrated in FIGS. 1-3 as separate forms 100-300, the three forms may be combined into a master form comprising one or more of forms 100-300 as sub-sections, and may further include additional sub-sections.

The sales comparison form 100 illustrated in FIG. 1 includes a subject column 110 corresponding to various details of the subject property, as well as a plurality of comp columns 120 corresponding to various details of the comps. Although FIG. 1 shows a form having three comp columns 120, a form may have room for more or fewer comps as desired. Form 100 further includes a plurality of property characteristic rows 130, each row corresponding to a property characteristic 131.

In the illustrated example, the property characteristics 131 include sale date, gross living area (GLA), lot size, exterior, quality of construction, age, condition, number of bedrooms, number of bathrooms, presence or absence of a basement, and presence or absence of a garage. Form 100 may, however, have more, fewer, or different property characteristics as desired.

Property characteristics 131 may be those found in a Uniform Residential Appraisal Report compliant with the UAD standard; for example, property characteristics 131 may include proximity to subject, sale price, sale price per GLA, financing concessions, date of sale, location, sale type (i.e., leasehold or fee simple), lot size, view, design (i.e., style), quality of construction, actual age, condition, above grade room count, GLA, finished rooms below grade, functional utility, HVAC, energy efficient items, garage, patio, fireplace, and the like.

For each property characteristic 131, the appraiser enters a value corresponding to the subject property in subject column 110, and values corresponding to the comps in respective comp columns 120. In FIG. 1, a hypothetical subject property has a GLA values of 2,000 ft², and hypothetical comps have respective GLA values of 2,200 ft², 2,500 ft², and 2,300 ft². For each instance where the subject property value differs from a comp, the appraiser enters an adjustment value corresponding to an amount by which the sale price of the comp is adjusted to account for the difference. In FIG. 1, the hypothetical appraiser entered an adjustment to the sale price of Comp #1 downward by $8,000, Comp #2 downward by $20,000, and Comp #3 downward by $12,000. After all relevant property characteristics 131 have been accounted for, the appraiser sums the adjustment values and calculates an adjusted sale price. In FIG. 1, the hypothetical appraiser has adjusted the sale price of Comp #1 downward by $15,000 for an adjusted price of $260,000, Comp #2 downward by $8,300 for an adjusted price of $241,700, and Comp #3 upward by $5,400 for an adjusted price of $230,400. Based on an appropriately weighted average of these adjusted prices, the appraiser calculates an appraised value for the subject property under the sales comparison approach. Note that, for property characteristics having discrete levels (such as condition having excellent, good, fair, poor, etc.), the data value may be codified numerically with each number corresponding to a particular level.

The cost form 200 illustrated in FIG. 2 includes a subject column 210 corresponding to various details of the subject property which are factors in the overall price of the subject property, as well as a contribution column 220 corresponding to the effect on price of respective ones of the various details. Subject column 210 includes a plurality of property characteristic rows 230, each row corresponding to a property characteristic 231.

In the illustrated example, the property characteristics 231 include an opinion of the site's value (for example, incorporating such sub-factors as lot size, view, neighborhood, and the like); a dwelling characteristic (for example, GLA multiplied by a value per unit area); indirect costs; a garage/carport characteristic (for example, gross area multiplied by a value per unit area); depreciation (which will be described in more detail below); and a value of site improvements (for example, value added by the presence of a deck).

In this example, the value is obtained by adding the site value and the estimated reproduction cost of improvements (that is, the residence), subtracting depreciation, and adding an “as-is” value of miscellaneous site improvements. In this manner, the value is representative of the cost to build a brand new similar property, minus the depreciation due to physical, functional, or external factors.

For example, if the subject property requires repairs, an amount may be indicated for physical depreciation. Additionally, if the subject property contains adverse design features such as a bedroom which can only be accessed from another bedroom, an amount may be indicated for functional depreciation. Furthermore, if the subject property abuts an adverse location such as a shopping mall or a heavily trafficked road, an amount may be indicated for external depreciation. The result of the above calculations results in an appraised value under the cost approach.

The income form 300 illustrated in FIG. 3 includes a property characteristic column 310 corresponding to an estimated monthly rental income to be derived from the subject property, as well as a multiplier column 320 corresponding a gross rent multiplier indicative of the number of months of rental income needed to earn back the property value. The gross rent multiplier may be calculated from similar properties at the time of sale; for example, by dividing the price of a recent sale by that property's current monthly rent. The value of estimated monthly rental income is multiplied by the gross rent multiplier to calculate an appraised value under the income approach.

In the example where a master form including sub-forms 100-300 is used, the master form may further include a reconciliation sub-form whereby the appraised values according to individual sub-forms 100-300 may be reconciled.

In various aspects of the present disclosure, a subject appraisal discrepancy analysis comprises operations that identify likely misrepresentation of the characteristics of a subject property.

### First Example

### Method

In a first example, the present disclosure provides a method for comparing multiple appraisals on the same subject property to detect likely fraud in a subject appraisal, and to generate various flags and system messages in response thereto.

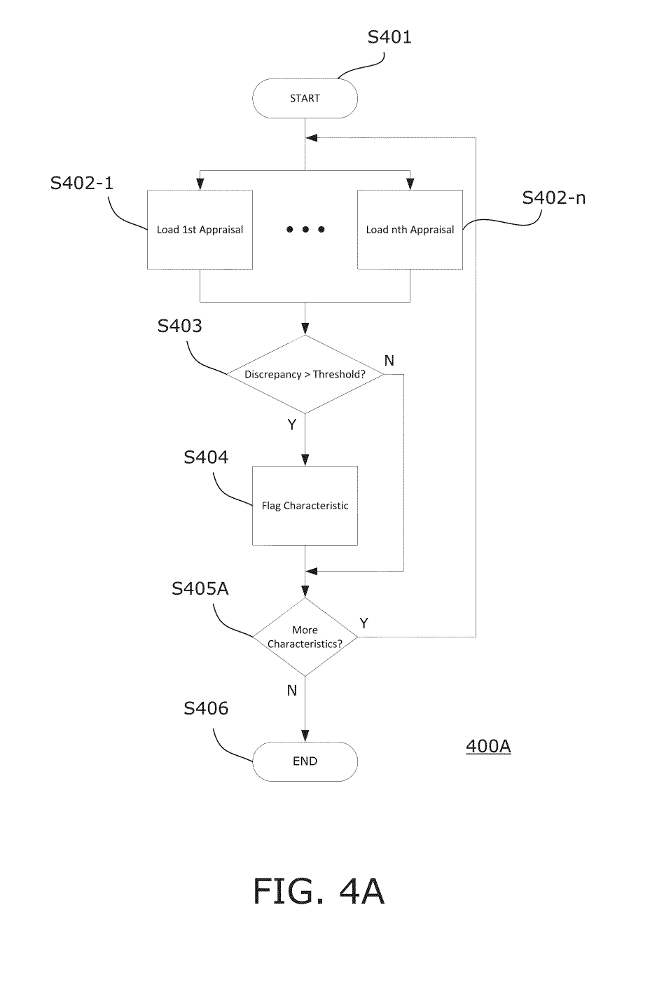

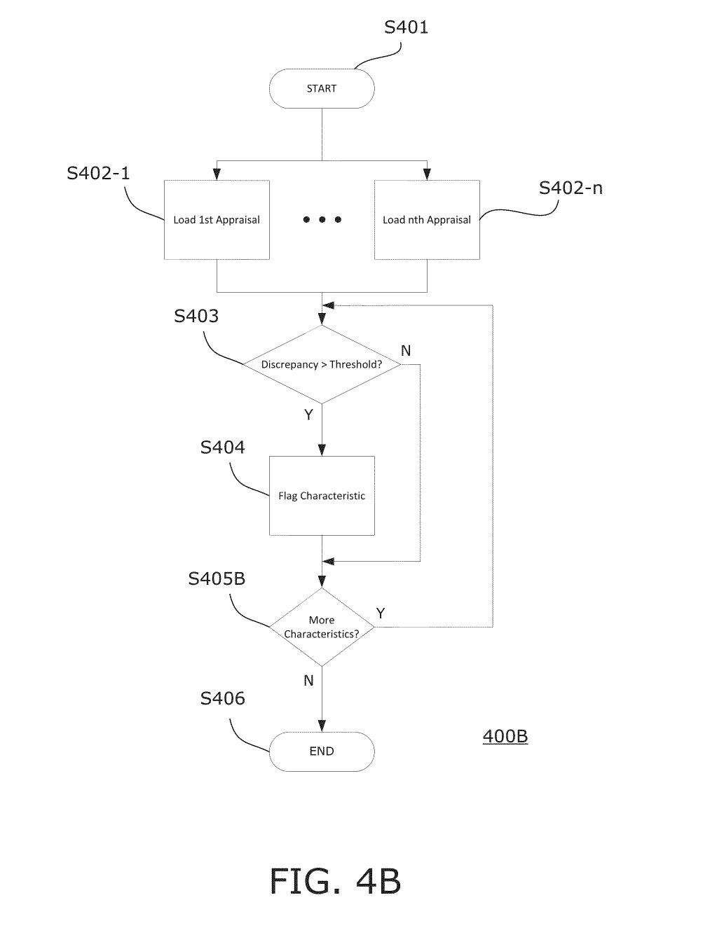

FIG. 4A represents an example of a flowchart illustrating operations performed by an exemplary method 400A. FIG. 4B represents a modification of FIG. 4A, and illustrates modified method 400B. In FIGS. 4A-B, the same steps are indicated using the same identifying label.

The exemplary method is initialized at step S401. The exemplary method then proceeds to steps S402-1 through S402-n, accesses one or more databases, and loads the subject property data contained within the one or more databases. Specifically, in step S402-1, the exemplary method loads a value of a property characteristic from a first appraisal of the subject property; in step S402-2 (not shown), the exemplary method loads a value of the property characteristic from a second appraisal of the same subject property; and so on, concluding with step S402-n where the exemplary method loads a value of the property characteristic from an nth appraisal of the same subject property. Although the exemplary method shows the loading steps being for all appraisals in parallel, the operations illustrated may be performed in series, in parallel, or in a combination of series and parallel. Here, the respective ones of the plurality of values correspond to respective property characteristics, such as property characteristics of the type described above with regard to FIGS. 1-3. For illustration purposes, the aforementioned “target appraisal” will be here treated as the first appraisal.

Once all relevant data has been loaded, the exemplary method proceeds to step S403 and compares individual appraisals to one another according to at least one rule set. The at least one rule set may include various rules for determining likely misrepresentation or fraud.

For example, the rule set may include a rule or rules whereby, in order to trigger a discrepancy flag, the most recent appraisal in the series must not indicate that the property has been recently updated. Furthermore, the rule set may include a rule whereby, in order to trigger a discrepancy flag, the property characteristic in question must differ by an amount greater than a predetermined threshold value between the first appraisal and another appraisal. In this manner, if the value for the property in question is within the predetermined tolerances, or has the relevant “update completed” indicator marked, for any previous appraisal of the same subject property, the characteristic escapes being flagged.

Depending on the particular property characteristic being analyzed, the tolerance may be in the form of an absolute difference, a percent difference, or a combination of the two. As such, if a discrepancy between the target appraisal and another appraisal exceeds this threshold, the rule set may determine that the discrepancy is the result of likely fraud or misrepresentation.

The rule set may further include a rule or rules to ignore a discrepancy that can be justified by looking at one or more additional appraisals done on the same property, so as not to artificially privilege a most recent appraisal over earlier ones if no major improvements have been made to the property. This is especially true if, although the most recent appraisal disagrees with an earlier appraisal, the most recent appraisal agrees with an intervening appraisal.

Additionally, the rule set may include a rule or rules to compare appraisal values with a secondary data source to determine if a discrepancy truly exists or if the secondary data source corroborates the data value supplied by the appraiser. The secondary data source may be one or more of assessment tax records, sales tax data, Multiple Listing Services (MLS), census data, and the like.

Furthermore, the rule set may include a rule or rules to weight discrepancies differently depending on their effect on the appraised value of the subject property. For example, the exemplary method may apply the rules to determine that a discrepancy is more likely to be fraudulent if it is more likely to increase the appraised value of the subject property.

Moreover, the rule set may include a rule or rules to evaluate discrepancies differently depending on a time difference between multiple subject appraisals on the same property. For example, the rule set may determine that, if there is a material difference between reported characteristics for a subject property in appraisals taken more than three months apart, the discrepancy may be flagged in the subsequent step with an informative message indicating that the property characteristic has changed with time. On the other hand, if there is a material difference between reported characteristics for a subject property in appraisals taken within three months of one another, the discrepancy may be flagged with both a message and a warning flag indicating that one or both of the reported characteristics is likely false. Threshold other than three months may be used, but this example uses a timeframe that has been demonstrated empirically to be meaningful.

After the relevant rules have been applied to the data, the exemplary method proceeds to step S404. In step S404, property characteristics are selectively flagged according to the results of the application of the rule set from step S403. In addition or alternative to flagging discrepancies, step S404 may comprise generating one or more messages to a user or operator (such as a user of the subject appraisal discrepancy application), and may comprise generating or updating a data value (or “score” comprising a number of “points”) which represents a likelihood that the subject appraisal is incorrect or fraudulent. This may be accomplished by appending flag data to the property characteristic data, or by creating a new flag data structure.

Upon completion of step S404, the exemplary method proceeds to step S405A and determines whether the process is complete; that is, whether there are additional property characteristics which require analysis. If no additional property characteristics require analysis, the exemplary method proceeds to step S406 and terminates. If any additional property characteristics require analysis, the exemplary method returns to steps S402-1 through S402-n and repeats.

In the modified example of FIG. 4B, the exemplary method proceeds to step S405B upon completion of step S404. If no additional property characteristics require analysis, the modified exemplary method similarly proceeds to step S406 and terminates. If any additional property characteristics require analysis, the exemplary method returns to steps S403 and repeats.

The exemplary method of FIG. 4A is useful in situations where there are many different appraisals and/or where individual appraisals contain many different property characteristics. In this manner, fewer data has to be loaded in steps S402-1 through S402-n and less memory is required. On the other hand, modified exemplary method of FIG. 4B is useful in situations where there are few appraisals and/or where individual appraisals contain few property characteristics. In this manner, all relevant data may be loaded in a single iteration of steps S402-1 through S402-n, and faster processing may be achieved.

One of ordinary skill in the art will recognize that the exemplary method may include combinations of the methods illustrated in FIGS. 4A and 4B. For example, property characteristics may be loaded in groups of two or more, such that the methods of FIGS. 4A and 4B are alternated.

The exemplary method need not load all available appraisals for a subject property, and may instead analyze only a subset thereof. For example, the exemplary method may compare multiple appraisals done within a short time period to determine whether, for example, loan officers are utilizing particular appraisers who may be more willing to appraise at a desired value which is unsupported by the underlying facts.

[Exemplary Rule Set]

One particular example of a rule set applied in steps S403 and S404 are presented below.

A first exemplary rule determines if a subject property's reported combined GLA differs from another appraisal of the same property. The first exemplary rule has a discrepancy threshold of more than 100 ft² between appraisals, between 10% and 90% of the total GLA, and no other subject appraisals within 5% of the total. If these conditions are met, a message is generated and the above-mentioned score may be increased by one point. If the appraisals were conducted more than three months apart, the score adjustment may be skipped.

Second and third exemplary rules determine if a subject property's reported bedroom or bathroom count, respectively, differs from another appraisal of the same property. If this condition is met, a message is generated and the score may be increased by one point for each violation. If the appraisals were conducted more than three months apart, the score adjustment may be skipped.

A fourth exemplary rule determines if a subject property's reported lot size differs from another appraisal of the same property. The first exemplary rule has a discrepancy threshold of more than 1000 ft² between appraisals, between 10% and 90% of the total lot size, and no other subject appraisals within 5% of the total. If these conditions are met, a message is generated and the above-mentioned score may be increased by one point. If the appraisals were conducted more than three months apart, the score adjustment may be skipped. Additionally, if the reported value is taken from the most recent tax record, the score adjustment may be skipped.

A fifth exemplary rule determines if a subject property's reported year built differs from another appraisal of the subject. The fifth exemplary rule has a discrepancy threshold of greater than 4 years and 10% of reported property age, but may be suppressed if both reported years are prior to a predetermined year (for example, 1946). If these conditions are met, a message is generated and the above-mentioned score may be increased by one point. If the appraisals were conducted more than three months apart, the score adjustment may be skipped. Additionally, if the reported value is taken from the most recent tax record, the score adjustment may be skipped.

Sixth through ninth exemplary rules determine if a subject property's reported location, view, quality, or condition, respectively, differs from another appraisal of the same property by two or more levels. If this condition is met, a message is generated and the score may be increased by one point for each violation. If the appraisals were conducted more than three months apart, the score adjustment may be skipped.

A tenth rule determines if there is a discrepancy between a first reported characteristic of a subject property and a second reported characteristic of the same property from the same appraisal; for example, if the subject property's reported condition level conflicts with what would be expected from the reported age. If this condition is met, a message is generated. The score may also be increased.

An eleventh rule determines if the total score for a subject appraisal indicates potential data integrity issues. For example, the score may be evaluated on a direct scale or normalized scale of 1 to 5, where 5 indicates potential data integrity issues. If this condition is met, a message is generated.

### Second Example

### Device

In a second example, the present disclosure provides a device for comparing multiple appraisals on the same subject property to detect likely fraud in a subject appraisal, and to generate various flags and system messages in response thereto. The second example may be a specialized or application-specific device for implementing the method described above with regard to the first example.

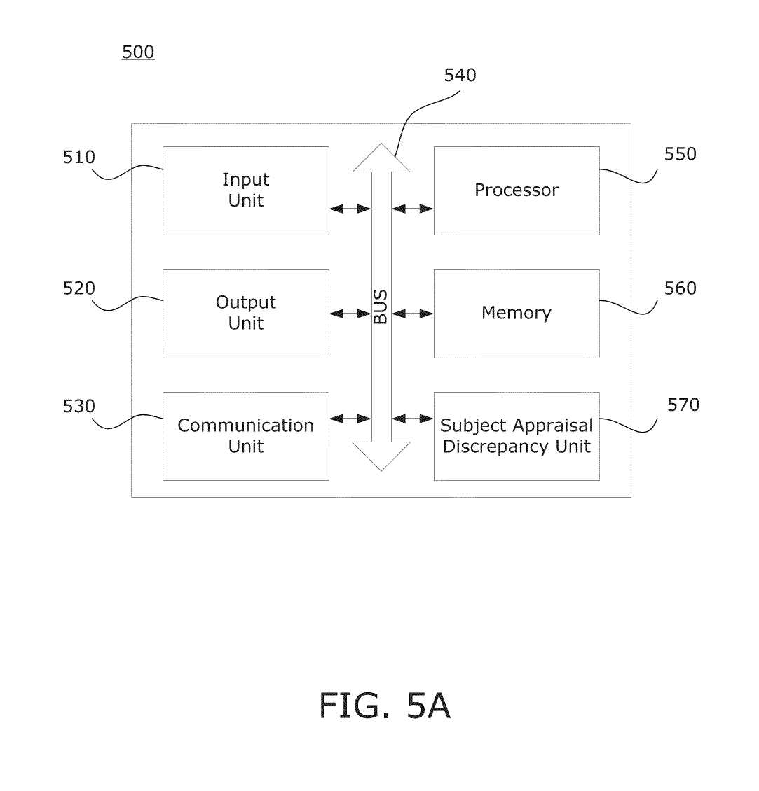

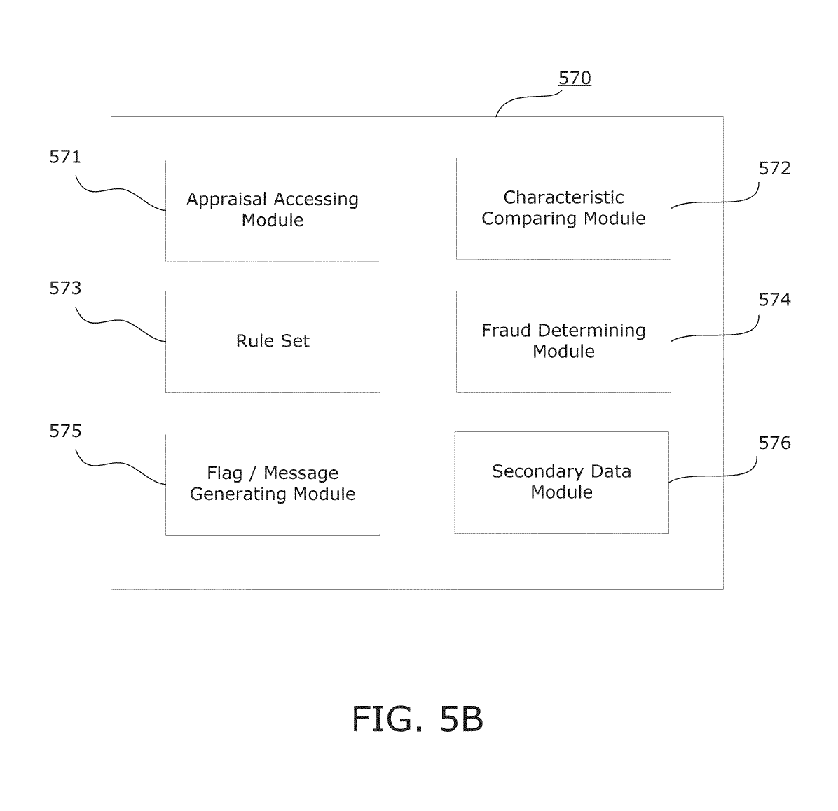

FIG. 5A is an example of a computing device 500 configured to perform operations comprising appraisal discrepancy analysis as described herein. The computing device 500 includes an input unit 510, an output unit 520, a communication unit 530, a processor 1050, a memory 1060, and a subject appraisal discrepancy unit 570. Individual units may be interconnected by a bus 540. The bus 540 may comprise a wired or wireless connection. The computing device 500 may be, for example, a personal computer, laptop computer, tablet device, smartphone, personal digital assistant, or the like. Although FIG. 5 shows the subject appraisal discrepancy unit 570 as a separate unit, the computing device 500 is not so limited. For example, the memory 560 may include a non-transitory computer readable medium including the appraisal adjustment rating unit 570. Alternatively, the computing device 500 may include an external computer program product, such as a CD-ROM, DVD-ROM, flash drive, or remote server, storing the subject appraisal discrepancy unit 570.

FIG. 5B is an example of subject appraisal discrepancy unit 570. The exemplary subject appraisal discrepancy unit includes an appraisal accessing module 571, a characteristic comparing module 572, a rule set 573, a fraud determining module 574, a flag/message generating module 575, and a secondary data module 576.

Appraisal accessing module 571 may be configured to access one or more appraisals of a subject property. Specifically, appraisal accessing module 571 may be configured to access one or more values respectively corresponding to one or more property characteristics for the appraisals. Characteristic comparing module 572 may be configured to compare a first appraisal and a second appraisal; specifically, to compare corresponding property characteristics among different appraisals of the same property. In so comparing, characteristic comparing module 572 may further be configured to access rule set 573 and/or access secondary data module 576.

Fraud determining module 574 may be configured to determine the likelihood of fraud or misrepresentation based on an output from characteristic comparing module 572. Where characteristic comparing module 572 is not configured to access rule set 573 and/or secondary data module 576, fraud determining module 574 may be so configured.

Flag/message generating module 575 may be configured to generate one or more flags and/or system messages based on an output from fraud determining module 574. Where neither characteristic comparing module 572 nor fraud determining module 574 are configured to access rule set 573 and/or secondary data module 576, flag/message generating module 575 may be so configured. Flag/message generating module 575 may further be configured to generate or update a score or point value indicative of the likelihood of fraud or misrepresentation.

Although illustrated as separate modules, two or more of the above-described modules may be combined. The various modules described above may be stored in memory 560, in the external computer program product, or in a remote device, and may be accessed by the computing device 500 via the internal bus 540 or via the communication unit 530 connected to, for example, a network. Additionally, some of the various modules may be stored in memory 560, while others may be distributed across other media such as the external computer program product or the remote device.

### Third Example

### System

In a third example, the present disclosure provides a system for comparing multiple appraisals on the same subject property to detect likely fraud in a subject appraisal, and to generate various flags and system messages in response thereto. The third example may be a specialized or application-specific system for implementing the method described above with regard to the first example and/or utilizing the devices described above with regard to the second example.

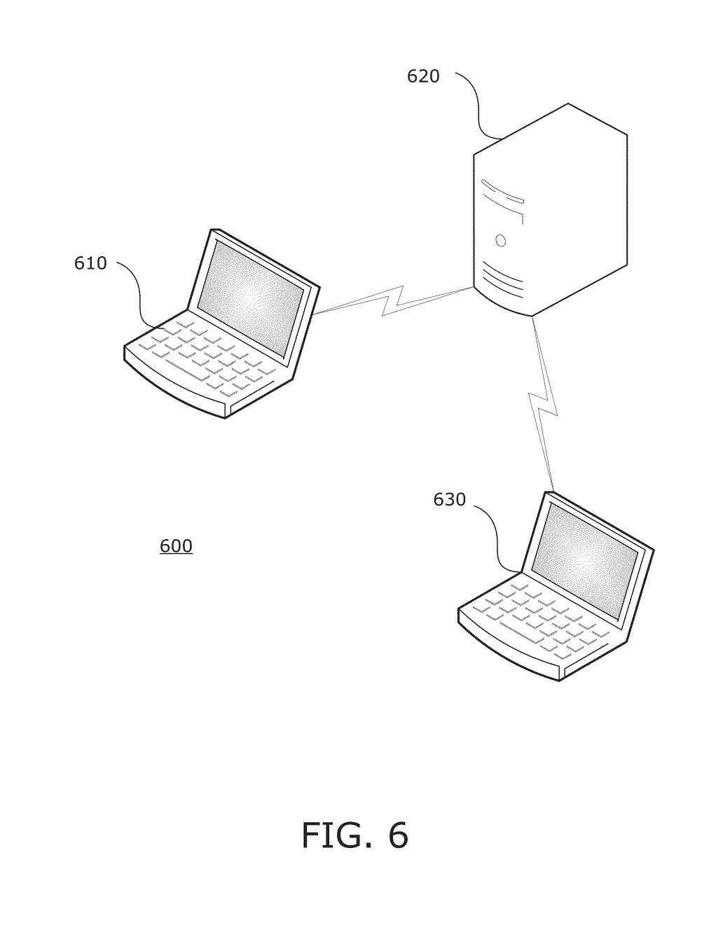

FIG. 6 is an example of a system 600 comprising one or more terminal computing devices 610, 630 connected to a server computing device 620. The computing devices 610-1130 may each be configured similarly to the above-described computing device 500. The system 600 may comprise operations as described above. Although the illustrated example shows one server and two terminals, the system may comprise more or fewer servers and/or terminals as desired.

The operations may be stored entirely in a memory of one of the computing devices 610-630, for example the server computing device 620. In such a configuration, the operations may be accessed by terminal computing devices 610, 630 via the network connection. Thereby, the terminal computing devices 610, 630 may execute the operations by accessing the program code stored on the server computing device 620.

Alternatively, the operations may be stored in a distributed manner across more than one computing device 610-630. In such a configuration, portions of the operations may be accessed by terminal computing devices 610, 630 via a network connection and other portions of the operations may be accessed by terminal computing devices 610, 630 from their respective internal memories. Thereby, a user may execute a user interface portion of the operations via a terminal computing device 610, causing the terminal computing device 610 to communicate with the server computing device 620. In response, the server computing device 620 may execute appropriate portions of the operations and communicate data generated therein to the terminal computing device 610 for storage, display, or further analysis. In an alternate configuration, respective portions of the operations may be performed by a plurality of computing devices in a distributed manner, for example by distributed parallel computing.

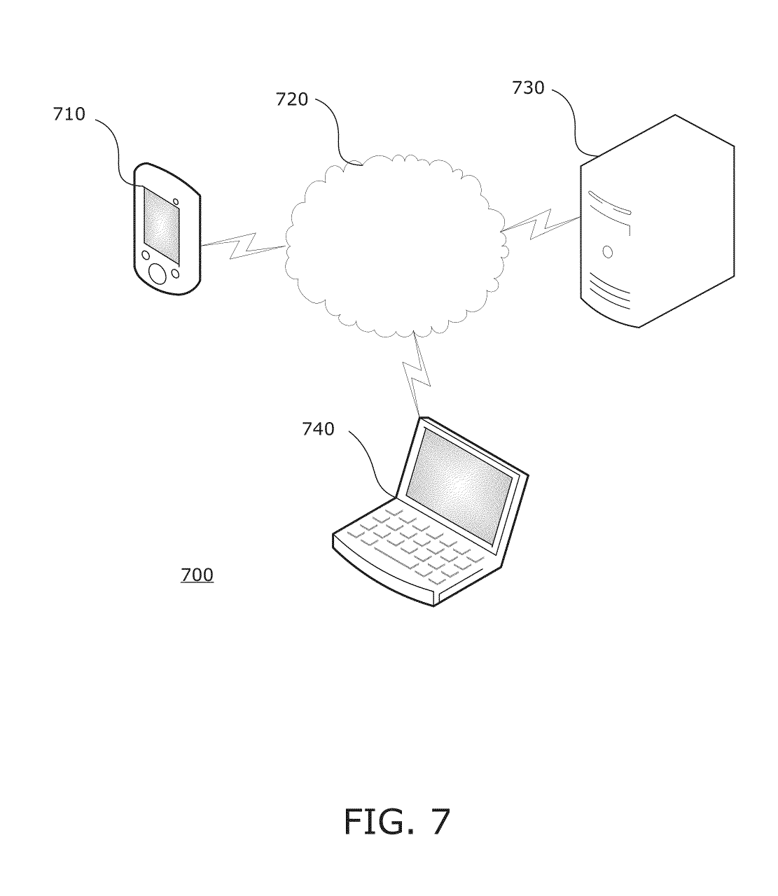

Although the example of FIG. 6 illustrates the computing devices 610-630 being connected via a private network such as a local area network (LAN), the system is not so limited. For example, FIG. 7 illustrates a system 700 wherein computing devices 710, 740, 730 are connected to one another via an intermediate network 720, such as the Internet. In this example, server computing device 730 may comprise a web server that hosts a webpage including data generated from operations executed by the server computing device 730, and users of terminal computing devices 710, 740 may view the data generated from the operations by opening the webpage on the respective terminal computing devices 710, 740.

Computing devices such as the computing devices 500, 610-630, 710, and 730-740 may generally include computer-executable instructions such as the instructions to perform the operations, where the instructions may be executable by one or more computing devices such as those listed above. Computer-executable instructions may be compiled or interpreted from computing programs created using a variety of programming languages and/or technologies, including but not limited to Java™, C, C++, C#, Fortran, Python, Visual Basic, PERL, COBOL, etc., and combinations thereof. Generally, a processor, for example, a microprocessor, receives instructions from, for example, a memory, a computer-readable medium, etc., and executes these instructions, thereby performing one or more processes, including one or more of the processes or subprocesses described herein. Such instructions and other data may be stored and transmitted using a variety of computer-readable media.

It is understood that as used herein, a processor may “perform” or “execute” a particular function by issuing the appropriate commands to other units, such as other components of the computing device, peripheral devices linked to the computing device, or other computing devices. As such, the commands may cause other units to take certain actions related to the function. For example, although a processor does not display an image in the sense of the processor itself physically emitting light in a pattern, the processor may nonetheless “execute” the function of “displaying” an image by issuing the appropriate commands to a display device that would then emit light in the requisite pattern. In this example, the display device that the processor causes to display the image may be part of the computing device that includes the processor, or may be connected remotely to the computing device that includes the processor by way of, for example, a network. In this manner, a processor included in a server hosting a webpage may “display” an image by issuing commands via the Internet to a remote computing device, the commands being such as would cause the remote computing device to display the image. Moreover, for the processor to have “executed” the particular function, the generation of a command that would cause another unit to perform the various actions of the function is sufficient, whether or not the other unit actually completes the actions.

A computer-readable medium described herein includes any non-transitory (tangible) medium that participates in providing data, such as instructions, that may be read by a computer. Such a medium may take a variety of forms, including but not limited to volatile media such as random access memory (RAM) or non-volatile media such as optical or magnetic disks. Such instructions may be transmitted via one or more transmission media, including coaxial cables, copper wire, and fiber optics, including the wires that comprise a system bus coupled to a processor of a computer. Common forms of computer-readable media include, for example, a floppy disk, a hard disk, magnetic tape, a CD-ROM, a DVD-ROM, punch cards, paper tape, RAM, flash memory, or any other medium from which a computer can read.

Databases, data repositories, data tables, or other data stores described herein may include various kinds of mechanisms for storing, accessing, and retrieving various kinds of data, including a hierarchical database, a set of files in a system, an application database in a proprietary format, a relational database management system (RDBMS), etc., or combinations thereof. Each such data store is typically included within a computing device employing a computer operating system such as those mentioned above, and are accessed via a network in a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

### CONCLUSION

With regard to the processes, systems, methods, submethods, algorithms, operations, etc., described herein, it should be understood that, although the steps of such operations have been described as occurring in a certain ordered sequence, such operations could be practiced with the described steps performed in an order other than the order described herein. It further should be understood that certain steps may be performed simultaneously, that other steps could be added, or that certain steps described herein could be omitted. In other words, the descriptions of operations herein are provided for the purpose of illustrating certain aspects of the application, and should not be construed so as to limit the scope of the application.

Accordingly, it is to be understood that the above description is intended to be illustrative and not restrictive or exhaustive. Although various aspects been described in considerable detail with reference to certain aspects thereof, the invention may be variously embodied without departing from the spirit or the scope of the invention. Therefore, many aspects and applications other than the specific examples provided herein would be apparent upon reading of the above description. It is anticipated and intended that future developments will occur in the technologies discussed herein, and that the disclosed systems and methods will be incorporated into such future embodiments. In other words, it should be understood that the application is capable of modification and variation.

1. An automated method for evaluating a property appraisal, comprising:
accessing, by a processor, at least a first data structure corresponding to a first appraisal of a property and at least a second data structure corresponding to a second appraisal of said property, wherein the first and second data structures include values corresponding to property characteristics of said property;
comparing, by the processor, the first data structure to the second data structure according to at least a first rule set; and
determining, by the processor, a likelihood of fraud, error, or data discrepancy based on a result of the comparison of the first and second data structures.

2. The method according to claim 1, wherein the first rule set includes a rule for creating a flag when a discrepancy between respective values for a given property characteristic according to the first data structure and the second data structure exceeds a predetermined threshold.

3. The method according to claim 2, wherein the first rule set includes a rule for creating or updating a score data structure when the discrepancy between respective values for the given property characteristic according to the first data structure and the second data structure exceeds the predetermined threshold.

4. The method according to claim 2, wherein flag data is appended to the respective value for the given property characteristic according to the first data structure when the discrepancy between respective values for the given property characteristic according to the first data structure and the second data structure exceeds the predetermined threshold.

5. The method according to claim 2, wherein flag data is stored in a flag data structure separate from the first data structure and the second data structure when the discrepancy between respective values for the given property characteristic according to the first data structure and the second data structure exceeds the predetermined threshold.

6. The method according to claim 1, wherein the first rule set includes a rule for preventing the creation of a flag when a most recent appraisal among the first appraisal and the second appraisal indicates that the property has been updated within a predetermined period of time.

7. The method according to claim 1, further comprising:
generating, by the processor, a message string indicating the presence and/or severity of a discrepancy based on the result of the comparison of the first and second data structures.

8. The method according to claim 1, wherein in the step of determining, a value of a given property characteristic for at least one of the first and second data structures is compared to a value of the given property characteristic in a secondary data source.

9. The method according to claim 8, wherein the secondary data source is selected from the group consisting of assessment tax records, sales tax data, Multiple Listing Services, census data, and combinations thereof.

10. The method according to claim 1, wherein the first data structure and the second data structure respectively correspond a plurality of property appraisals, respective ones of said plurality of property appraisals having been conducted within a predetermined time period of each other.

11. The method according to claim 10, wherein the predetermined time period is three months.

12. A computer program product comprising a non-transitory computer readable medium having program code stored thereon, the program code being executable by a processor to perform operations comprising:
accessing, by the processor, at least a first data structure corresponding to a first appraisal of a property and at least a second data structure corresponding to a second appraisal of said property, wherein the first and second data structures include values corresponding to property characteristics of said property;
comparing, by the processor, the first data structure to the second data structure according to at least a first rule set; and
determining, by the processor, a likelihood of fraud, error, or data discrepancy based on a result of the comparison of the first and second data structures.

13. A computing device, comprising:
at least one processor; and
a memory unit, the memory unit having stored thereon program code executable by the at least one processor to perform operations comprising:
accessing, by the processor, at least a first data structure corresponding to a first appraisal of a property and at least a second data structure corresponding to a second appraisal of said property, wherein the first and second data structures include values corresponding to property characteristics of said property;
comparing, by the processor, the first data structure to the second data structure according to at least a first rule set; and
determining, by the processor, a likelihood of fraud, error, or data discrepancy based on a result of the comparison of the first and second data structures.
